(19) United States
(12) Patent Application Publication
(10) Pub. No.: US 2024/0215115 A1
(43) Pub. Date: Jun. 27, 2024

(54) ELECTRONIC ATOMIZATION DEVICE AND CONTROL METHOD THEREFOR

(71) Applicant: SHENZHEN SMOORE TECHNOLOGY LIMITED, Shenzhen (CN)

(72) Inventors: Xumin XIA, Shenzhen (CN); Weiming FANG, Shenzhen (CN)

(21) Appl. No.: 18/594,635

(22) Filed: Mar. 4, 2024

Related U.S. Application Data
(63) Continuation of application No. PCT/CN2022/112217, filed on Aug. 12, 2022.

(30) Foreign Application Priority Data
Sep. 6, 2021 (CN) 202111038430.9

(51) Int. Cl. H05B 1/02

(52) U.S. Cl. CPC H05B 1/0297

(57) ABSTRACT

An electronic atomization device includes: a heating element; and a control module for: controlling the heating element to heat in a heating period of a first time segment of a current time window, and detecting a resistance value of the heating element in a non-heating period of the first time segment of the current time window; controlling the heating element to heat in a heating period of an intermediate time segment of the current time window, and controlling the heating element to stop heating or detect the resistance value of the heating element in a non-heating period of the intermediate time segment of the current time window; and controlling the heating element to heat in a heating period of a final time segment of the current time window. The intermediate time segment is a different time segment than the first and final time segments in the current time window.

### CROSS-REFERENCE TO PRIOR APPLICATION

This application is a continuation of International Patent Application No. PCT/CN2022/112217, filed on Aug. 12, 2022, which claims priority to Chinese Patent Application No. 202111038430.9, filed on Sep. 6, 2021. The entire disclosure of both applications is hereby incorporated by reference herein.

### FIELD

The present invention relates to the field of atomization devices, and in particular, to an electronic atomization device and a control method therefor.

### BACKGROUND

An electronic atomization device is a device that can atomize an aerosol-forming substrate in an atomizer, and has advantages such as safety, convenience, health, and environmental protection, thereby becoming more and more popular.

Most of existing electronic atomization devices atomize the aerosol-forming substrate in a constant power heating manner.

In a first method, a constant power output is obtained in a manner of modulating a duty cycle of a PWM wave. Specifically, as shown in FIG. 1, a large period T is divided into a plurality of small periods of equal duration, and heating duration of each small period in a same large period is fixed, in other words, a duty cycle of a large period is constant. Duty cycles of different large periods may change. In addition, after a large period is run each time, an output of a PWM signal is turned off, and a resistance value of a heating element is detected based on a current voltage U2 of the heating element and a voltage U1 of the heating element during heating.

In a second method, a voltage of a heating element and a flowing current are periodically monitored to obtain current power. If the power obtained through monitoring is less than target power, heating is continued. If the power obtained through monitoring is greater than the target power, heating is stopped. Heating is resumed when actual average power is less than the target power.

### SUMMARY

In an embodiment, the present invention provides an electronic atomization device, comprising: a heating element; and a control module configured to: control the heating element to heat in a heating period of a first time segment of a current time window, and detect a resistance value of the heating element in a non-heating period of the first time segment of the current time window; control the heating element to heat in a heating period of an intermediate time segment of the current time window, and control the heating element to stop heating or detect the resistance value of the heating element in a non-heating period of the intermediate time segment of the current time window; and control the heating element to heat in a heating period of a final time segment of the current time window, wherein the intermediate time segment is a different time segment than the first time segment and the final time segment in the current time window, and wherein the heating period of the intermediate time segment and the heating period of the final time segment are respectively related to consumed energy and consumed time of a time segment that has been run.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a curve diagram showing a relationship between a voltage and time of a heating element of an existing electronic atomization device;

FIG. 2 is a logical structure diagram of Embodiment 1 of an electronic atomization device according to the present invention;

FIG. 3 is a curve diagram showing a relationship between a voltage and time of a heating element of an electronic atomization device according to an embodiment of the present invention;

FIG. 4 is a curve diagram showing a relationship between a voltage and time of a heating element of an electronic atomization device according to an embodiment of the present invention;

FIG. 5 is a curve diagram showing a relationship between a voltage and time of a heating element of an electronic atomization device according to an embodiment of the present invention;

FIG. 6 is a logical structure diagram of Embodiment 2 of an electronic atomization device according to the present invention; and

FIG. 7 is a flowchart of Embodiment 1 of a method for controlling an electronic atomization device according to the present invention.

### DETAILED DESCRIPTION

In an embodiment, the present invention provides a solution to the technical problem that a constant power output cannot be guaranteed in the initial stage of heating in existing technologies.

In an embodiment, the present invention provides an electronic atomization device, including a heating element, and further including:
a control module, configured to control the heating element to heat in a heating period of a first time segment of a current time window, and detect a resistance value of the heating element in a non-heating period of the first time segment of the current time window; control the heating element to heat in a heating period of an intermediate time segment of the current time window, and control the heating element to stop heating or detect the resistance value of the heating element in a non-heating period of the intermediate time segment of the current time window; and control the heating element to heat in a heating period of a final time segment of the current time window, where
the intermediate time segment is another time segment than the first time segment and the final time segment in the current time window, and the heating period of the intermediate time segment and the heating period of the final time segment are respectively related to consumed energy and consumed time of a time segment that has been run.

Preferably, the heating period and the non-heating period of the first time segment of the current time window are initial set values; or

the heating period and the non-heating period of the first time segment of the current time window are related to running of a plurality of time segments in a previous time window.

Preferably, segment duration of time segments of the current time window is equal; or
the segment duration of the time segments of the current time window is not exactly equal.

Preferably, segment duration of the intermediate time segment is determined by using Formula 1:

$${t}_{x} = {t}_{left ( x - 1 )} / {g}_{x} , \qquad Formula 1$$

where
tₓ is segment duration of an x^{th} time segment, x=2, 3, . . . , or n−1, n is a total quantity of time segments of the current time window, gₓ is a set value corresponding to the x^{th} time segment, and gₓ is an integer greater than 1.

Preferably, heating periods of time segments of the current time window are equal; or
the heating periods of the time segments of the current time window are not exactly equal.

Preferably, the heating period of the intermediate time segment and the heating period of the final time segment are respectively related to actual power of a previous time segment, remaining duration of the current time window, and remaining energy of the current time window.

Preferably, if the heating element is controlled to stop heating in the non-heating period of the intermediate time segment of the current time window, the heating period of the intermediate time segment is determined by using Formula 2:

$${t}_{left ( t - 1 )} * {P}_{t ( x - 1 ) A} * {t}_{xA} / {t}_{x} = {E}_{left ( x - 1 )} ; \qquad Formula 2$$

and
if the resistance value of the heating element is detected in the non-heating period of the intermediate time segment of the current time window, the heating period of the intermediate time segment is determined by using Formula 3:

$${t}_{left ( x - 1 )} * ( {P}_{t ( x - 1 ) A} * {t}_{xA} + {P}_{t ( x 331 \; 1 ) B} * ( {t}_{x} - {t}_{xA} ) ) / {t}_{x} = {E}_{left ( x - 1 )} , \qquad Formula 3$$

where
tₓ is segment duration of an x^{th} time segment, x=2, 3, . . . , or n−1, n is a total quantity of time segments of the current time window, t_{xA} is a heating period of the x^{th} time segment, t_{left(x-1)} is the remaining duration of the current time window, P_{t(x-1)A} is first actual power of the heating element in a heating period of an (x−1)^{th} time segment, P_{t(x-1)B} is second actual power of the heating element in a non-heating period of the (x−1)^{th} time segment, and E_{left(x-1)} is the remaining energy of the current time window.

Preferably, the heating period of the final time segment is determined according to the following manners:
if first actual power of the heating element in a heating period of a penultimate time segment is greater than or equal to a ratio of the remaining energy to the remaining duration of the current time window, the ratio is used as the heating period of the final time segment; and
if the first actual power of the heating element in the heating period of the penultimate time segment is less than the ratio of the remaining energy to the remaining duration of the current time window, the remaining duration is used as the heating period of the final time segment.

Preferably, the electronic atomization device further includes a first switch circuit, a second switch circuit, a reference resistor, and a voltage sampling module, where the first end of the second switch circuit and the first end of the first switch circuit are respectively connected to the positive end of a power supply, the second end of the second switch circuit is connected to the first end of the reference resistor, the second end of the reference resistor and the second end of the first switch circuit are respectively connected to the first end of the heating element, the second end of the heating element is grounded, the input end of the voltage sampling module is connected to the first end of the heating element, and the output end of the voltage sampling module is connected to the voltage detection end of the control module.

The present invention further constructs a method for controlling an electronic atomization device, including:
controlling a heating element to heat in a heating period of a first time segment of a current time window;
detecting a resistance value of the heating element in a non-heating period of the first time segment of the current time window;
controlling the heating element to heat in a heating period of an intermediate time segment of the current time window, where the intermediate time segment is another time segment than the first time segment and a final time segment in the current time window, and the heating period of the intermediate time segment is related to consumed energy and consumed time of a time segment that has been run;
controlling the heating element to stop heating or detecting the resistance value of the heating element in a non-heating period of the intermediate time segment of the current time window; and
controlling the heating element to heat in a heating period of the final time segment of the current time window, where the heating period of the final time segment is related to consumed energy and consumed time of a time segment that has been run.

Preferably, segment duration of time segments of the current time window is equal; or
the segment duration of the time segments of the current time window is not exactly equal.

Preferably, heating periods of time segments of the current time window are equal; or
the heating periods of the time segments of the current time window are not exactly equal.

### Beneficial Effects

By implementing the technical solutions in the present invention, heating duration of a to-be-run time segment in each time window can be adjusted in real time according to running of a time segment that has been run by a heating element. Therefore, even in the initial stage of heating, it can precisely ensure that energy released by the heating element in a time window is close to total target energy, without adjustment through a plurality of periods. Therefore, a constant power output has higher precision.

The technical solutions of embodiments of the present invention are clearly and completely described below with reference to the accompanying drawings in the embodiments of the present invention. The described embodiments are merely a part rather than all of the embodiments of the present invention. All other embodiments obtained by a person of ordinary skill in the art based on the embodiments of the present invention without creative efforts shall fall within the protection scope of the present invention.

First, to implement constant power heating in an electronic atomization device, the following is required to be satisfied: Target power P outputted in a time window (whose total duration is T) is a fixed value (for example, 6.5 W), in other words, energy outputted in each time window is P*T. In this case, it can be considered as constant power heating. In actual applications, if energy outputted in each time window is closer to P*T, it is considered that controlling for constant power heating is more precise.

FIG. 2 is a logical structure diagram of Embodiment 1 of an electronic atomization device according to the present invention. The electronic atomization device in this embodiment includes a control module 11 and a heating element R2. In addition, the control module 11 is configured to control the heating element R2 to heat in a heating period of a first time segment of a current time window, and detect a resistance value of the heating element R2 in a non-heating period of the first time segment of the current time window; control the heating element R2 to heat in a heating period of an intermediate time segment of the current time window, and control the heating element R2 to stop heating or detect the resistance value of the heating element R2 in a non-heating period of the intermediate time segment of the current time window; and control the heating element R2 to heat in a heating period of a final time segment of the current time window, where the intermediate time segment is another time segment than the first time segment and the final time segment in the current time window, and the heating period of the intermediate time segment and the heating period of the final time segment are respectively related to consumed energy and consumed time of a time segment that has been run.

For this embodiment, the following content needs to be described.
(1) A time window (whose total duration T may be, for example, 8 milliseconds or 10 milliseconds) is divided into a plurality of time segments, and segment duration of the plurality of time segments is necessarily less than T. Generally, a larger quantity of time segments divided in a time window indicates that a real situation of a heating process can be more dynamically, and also indicates higher precision. However, when dividing the time window, a sampling time t_{ADC} of an analog-to-digital conversion module of an MCU in the control module is also necessarily considered. In other words, it is necessary to ensure that segment duration of each time segment is not less than 2*t_{ADC}. In this way, it can be ensured that a voltage of the heating element can be sampled in each time segment. If the selected sampling time t_{ADC} of the analog-to-digital conversion module is shorter, the time window may be divided into a larger quantity of time segments, for example, may be divided into 100 time segments. In actual applications, performance of the MCU and computing complexity are also necessarily considered, to divide an appropriate quantity of time windows according to an actual situation.

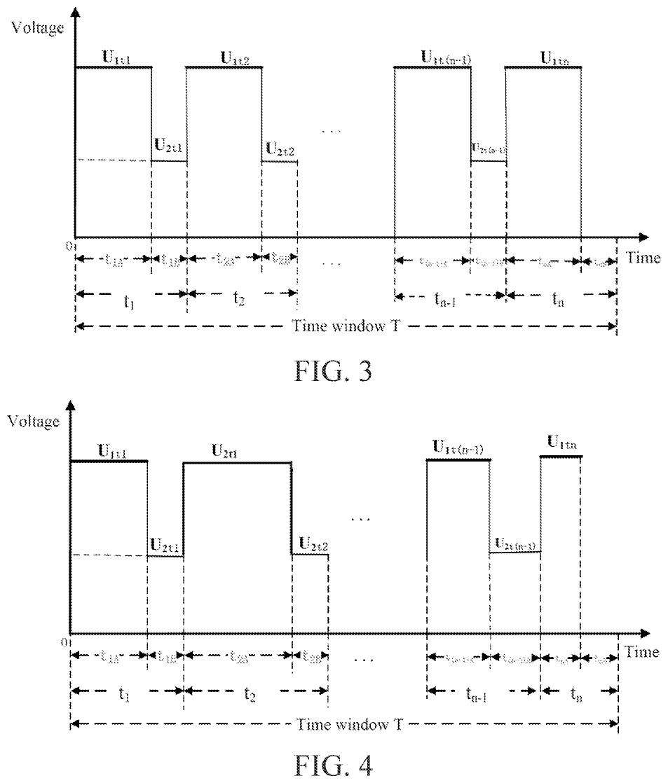

In addition, in a specific example, segment duration of time segments of the current time window is equal. As shown in FIG. 3, a time window is divided into n time segments of fixed duration, that is, t₁=t₂= . . . =tₙ₋₁=tₙ, where t₁, t₂, . . . , tₙ₋₁, and tₙ are respectively segment duration of a first time segment, a second time segment, . . . , an (n−1)^{th} time segment, and an n^{th} time segment. In a specific application, considering computing complexity and performance of the MCU in the control module, when dividing the time window into fixed duration, it is assumed that total duration of a time window is 8 ms. When the time window is equally divided into 32 time segments, segment duration of each time segment is 250 us. In another specific example, the segment duration of the time segments of the current time window is not exactly equal. As shown in FIG. 4, t₁, t₂, . . . , tₙ₋₁, and tₙ are not exactly equal.
(2) Generally, the heating element has two running stages in a time segment: a heating period and a non-heating period, and neither period is 0. Specially, a final time segment (as an energy compensation time segment) may have only a heating period. In other words, segment duration of the entire time segment is the heating period, and a non-heating period is 0. The control module controls the heating element to heat in a heating period of each time segment; the control module controls the heating element to stop heating or detects the resistance value of the heating element in a non-heating period of another time segment than the final time segment; and for the final time segment, regardless of whether a non-heating period thereof exists, the resistance value of the heating element is not detected.

In addition, in a specific example, heating periods of time segments of the current time window are equal. As shown in FIG. 3, t_{1A}=t_{2A}= . . . =t_{(n-1)A}=t_{nA}, where t_{1A}, t_{2A}, . . . , t_{(n-1)A}, and t_{nA} are respectively heating periods of a first time segment, a second time segment, . . . , an (n−1)^{th} time segment, and an n^{th} time segment. In another specific example, the heating periods of the time segments of the current time window are not exactly equal. As shown in FIG. 4, t_{1A}, t_{2A}, . . . , t_{(n-1)A}, and t_{nA} are not exactly equal.

Similarly, in a specific example, non-heating periods of time segments of the current time window is equal. As shown in FIG. 3, t_{1B}=t_{2B}= . . . =t_{(n-1)B}=t_{nB}, where t_{1B}, t_{2B}, . . . , t_{(x-1)B}, and t_{nB} are respectively non-heating periods of a first time segment, a second time segment, . . . , an (n−1)^{th} time segment, and an n^{th} time segment. In another specific example, the non-heating periods of the time segments of the current time window are not exactly equal. As shown in FIG. 4, t_{1B}, t_{2B}, . . . , t_{(x-1)B}, and t_{nB} are not exactly equal.
(3) In a time window, a non-heating period of a first time segment is for detecting the resistance value of the heating element, and a non-heating period of a subsequent intermediate time segment may also be for detecting the resistance value of the heating element. The resistance value of the heating element is detected to adjust an energy release mode of a subsequent time segment in the time window. In other words, according to consumed energy (where the consumed energy is related to the detected resistance value of the heating element) and consumed time of a time segment that has been run, a heating period of a subsequent time segment is dynamically adjusted to ensure that energy released by the heating element in a time window is close to total target energy.

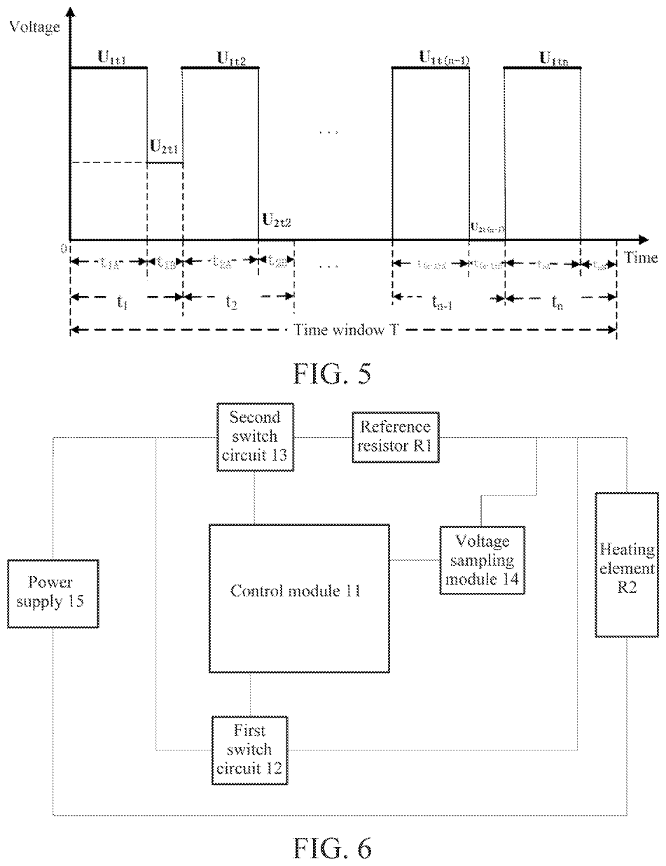

In addition, in a specific example, the resistance value of the heating element may be detected in each of non-heating periods of all other time segments than a final time segment, as shown in FIG. 3 or FIG. 4. In another specific example, if the resistance value of the heating element is fixed or the resistance value changes very little when temperature changes, the resistance value of the heating element may be detected only in the non-heating period of the first time segment, and the resistance value is not detected in non-heating periods of other time segments, as shown in FIG. 5. Certainly, in other specific examples, in addition to detecting the resistance value in the non-heating period of the first time segment, the resistance value is further detected in non-heating periods of some intermediate time segments.

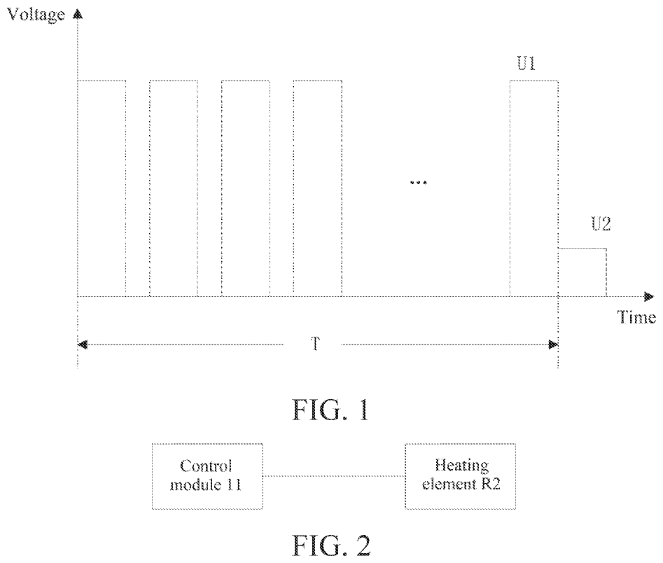

Differences between curves showing a relationship between a voltage and time of the heating element in the solution of the present invention and the existing solution are described below with reference to FIG. 1 and FIG. 3 to FIG. 5.
(1) For an existing PWM control manner, as shown in FIG. 1, a frequency in each time window remains unchanged (in other words, duration of each small period is fixed), a duty cycle of each time window is fixed (in other words, a heating period of each small period is fixed), and certainly, duty cycles in different time windows may change. For example, it is assumed that duration T of a time window is equal to 8 ms and a frequency of a PWM signal is 4 KHz. In this case, a time window has 32 small periods, and duration of each small period is 250 us. In addition, in each small period, heating duration is fixed. Assuming that a duty cycle is 60%, the heating duration of each small period is 150 us (250 us*60%), and non-heating duration is 90 us. For a control manner of the control module in the present invention, in a time window, segment duration of time segments may be equal (as shown in FIG. 3), or may be not equal (as shown in FIG. 4); and heating periods of the time segments may be equal (as shown in FIG. 3), or may be not equal (as shown in FIG. 4).
(2) For the existing PWM control manner, as shown in FIG. 1, the resistance value of the heating element is detected after a time window is run. A detection period of the resistance value does not occupy a time window, and a purpose of detecting the resistance value is to adjust power of next time window, that is, adjust a duty cycle of the next time window. Specifically, if average power (related to the resistance value of the heating element) in a current time window is greater than target power, a duty cycle of next time window is reduced (for example, the duty cycle is changed to 50%, heating duration=125 us, non-heating duration is 125 us). If the average power (related to the resistance value of the heating element) in the current time window is less than the target power, the duty cycle of the next time window is increased (for example, the duty cycle is changed to 70%, the heating duration=175 us, the non-heating duration is 75 us). In other words, heating duration and non-heating duration of each small period in a time window are determined before starting of the current time window, and remain unchanged subsequently. Therefore, the PWM control manner can only make average power in subsequent periods close to the target power, but it is difficult to ensure a constant power output in the initial stage of heating. For the control manner of the control module in the present invention, as shown in FIG. 3 to FIG. 5, in each time window, the resistance value of the heating element is detected at least in a non-heating period of a first time segment. Certainly, the resistance value of the heating element may also be detected in a non-heating period of a subsequent intermediate time segment. A final time segment is an energy compensation time segment, and the resistance value of the heating element is not detected. A purpose of detecting the resistance value of the heating element is to adjust an energy release manner of a subsequent time segment in a current time window. In other words, in a time window, a heating period and a non-heating period of each time segment are not predetermined, but are dynamically adjusted in real time according to consumed energy and time. In this way, it can be ensured that average power of each time window can be close to the target power. Therefore, even in the initial stage of heating, a constant power output can be guaranteed.

Through the technical solutions in the present invention, heating duration of a to-be-run time segment in each time window can be adjusted in real time according to running of a time segment that has been run by a heating element. Therefore, even in the initial stage of heating, it can precisely ensure that energy released by the heating element in a time window is close to total target energy, without adjustment through a plurality of periods. Therefore, a constant power output has higher precision.

Further, in an optional embodiment, the heating period and the non-heating period of the first time segment of the current time window are initial set values. In a specific application, it is assumed that sampling duration t_{ADC} of the analog-to-digital conversion module of the MCU is 50 microseconds, target power is 6.5 W, power during heating is about 10 W (where a voltage during heating is more than 3 V, and the resistance value of the heating element is about 1 ohm), and segment duration of each time segment is 250 us. In this case, according to the heating power and the initial resistance value of the heating element, it can be calculated that a heating period of each time segment is about 6.5 W*250 us/10 W=162.5 us. Therefore, a heating period t_{1A} of the first time segment may be set to 160 us, and a non-heating period t_{1B} may be set to 90 us (both are greater than t_{ADC}).

In another optional embodiment, the heating period and the non-heating period of the first time segment of the current time window are related to running of a plurality of time segments in a previous time window.

Further, in a specific embodiment, segment duration of the intermediate time segment is determined by using Formula 1:

$${t}_{x} = {t}_{left ( x - 1 )} / {g}_{x} , \qquad Formula 1$$

where

tₓ is segment duration of an x^{th} time segment, x=2, 3, . . . , or n−1, n is a total quantity of time segments of the current time window, gₓ is a set value corresponding to the x^{th} time segment, and gₓ is an integer greater than 1.

In this embodiment, set values respectively corresponding to different time segments may be preset. For different values of gₓ, a plurality of time segments in the current time window may be implemented as time segments of unfixed duration, or the plurality of time segments in the current time window may be implemented as time segments of fixed duration. For example, in a special situation, when x=2, g₂=31; when x=3, g₃=30; and the rest is deduced by analogy.

Further, in an optional embodiment, the heating period of the intermediate time segment and the heating period of the final time segment are respectively related to actual power of a previous time segment, remaining duration of the current time window, and remaining energy of the current time window. In this embodiment, after the heating period t_{1A} (for example, 160 us) and the non-heating period t_{1B} (for example, 90 us) of the first time segment are determined, a heating period t_{2A} and a non-heating period t_{2B} of a second time segment may be determined according to actual power, the current remaining duration, and the remaining energy in the first time segment; and the rest is deduced by analogy, until a heating period t_{nA} and a non-heating period t_{nB} (if exist) of the final time segment are determined.

In a specific embodiment, for the intermediate time segment, namely, the x^{th} time segment, x=2, 3, . . . , or n−1, n, and n is the total quantity of time segments of the current time window. A manner of determining the heating period of the intermediate time segment includes the following two situations:
First situation: If the heating element is controlled to stop heating in the non-heating period of the intermediate time segment, the heating period of the intermediate time segment is determined by using Formula 2:

$${t}_{left ( t - 1 )} * {P}_{t ( x - 1 ) A} * {t}_{xA} / {t}_{x} = {E}_{left ( x - 1 )} . \qquad Formula 2$$

Second situation: If the resistance value of the heating element is detected in the non-heating period of the intermediate time segment, the heating period of the intermediate time segment is determined by using Formula 3:

$${t}_{left ( x - 1 )} * ( {P}_{t ( x - 1 ) A} * {t}_{xA} + {P}_{t ( x 331 \; 1 ) B} * ( {t}_{x} - {t}_{xA} ) ) / {t}_{x} = {E}_{left ( x - 1 )} . \qquad Formula 3$$

tₓ is segment duration of the x^{th} time segment, t_{xA} is a heating period of the x^{th} time segment, t_{left(x-1)} is the remaining duration of the current time window, P_{t(x-1)A} is first actual power of the heating element in a heating period of an (x−1)^{th} time segment, P_{t(x-1)B} is second actual power of the heating element in a non-heating period of the (x−1)^{th} time segment, and E_{left(x-1)} is the remaining energy of the current time window.

In this embodiment, a heating period of each intermediate time segment is always determined based on a principle that remaining energy is evenly released in remaining duration. Therefore, it can be ensured that total target energy (P*T) is more evenly released in a time window.

In a specific embodiment, the heating period of the final time segment may be determined according to the following manners:
if first actual power of the heating element in a heating period of a penultimate time segment is greater than or equal to a ratio of the remaining energy to the remaining duration of the current time window, the ratio is used as the heating period of the final time segment; and
if the first actual power of the heating element in the heating period of the penultimate time segment is less than the ratio of the remaining energy to the remaining duration of the current time window, the remaining duration is used as the heating period of the final time segment.

In this embodiment, in the current time window, after an (n−1)^{th} time segment is run, for a to-be-run n^{th} time segment, if P_{t(n-1)A}*t_{left(n-1)}>=E_{left(n-1)}, a heating period of the n^{th} time segment is E_{left(n-1)}/P_{t(n-1)A}, and correspondingly, a non-heating period is t_{left(n-1)}−E_{left(n-1)}/P_{t(n-1)A}; and if P_{t(n-1)A}*t_{left(n-1)}<E_{left(n-1)}, heating period of the n^{th} time segment is t_{left(n-1)}.

FIG. 6 is a logical structure diagram of Embodiment 2 of an electronic atomization device according to the present invention. The electronic atomization device in this embodiment includes a control module 11, a heating element R2, a first switch circuit 12, a second switch circuit 13, a reference resistor R1, and a voltage sampling module 14, and in addition, may further include a power supply 15. The first end of the second switch circuit 13 and the first end of the first switch circuit 12 are respectively connected to the positive end of the power supply 15, the second end of the second switch circuit 13 is connected to the first end of the reference resistor R1, the second end of the reference resistor R1 and the second end of the first switch circuit 12 are respectively connected to the first end of the heating element R2, the second end of the heating element R2 and the negative end of the power supply 15 are grounded, the input end of the voltage sampling module 14 is connected to the first end of the heating element R2, and the output end of the voltage sampling module 14 is connected to the voltage detection end of the control module 11.

A process of detecting a resistance value of the heating element R2 is described below with reference to FIG. 3 to FIG. 6.

First, the heating element R2 may be selected as a resistance heating wire. In a heating process, the resistance value of the heating element R2 may change with temperature. The reference resistor R1 (whose resistance value is known) is generally selected as a resistor whose resistance value is a plurality of times that of the heating element R2.

When starting to run a specific time segment, in a heating period of the time segment, the control module 11 controls the first switch circuit 12 to be turned on, and simultaneously controls the second switch circuit 13 to be turned off. In this case, the power supply 15 supplies power to the heating element R2, and the heating element R2 starts to generate heat. In addition, the control module 11 further acquires a voltage of the heating element R2 through the voltage sampling module 14, to obtain a detection voltage U1 (which may be considered as a power supply voltage) on the heating element R2. In a non-heating period of the time segment, the control module 11 controls the first switch circuit 12 to be turned off, and simultaneously controls the second switch circuit 13 to be turned on. In this case, the power supply 15 supplies power to the reference resistor R1 and the heating element R2. In addition, the control module 11 further acquires the voltage of the heating element R2 through the voltage sampling module 14, to obtain a detection voltage U2 on the heating element R2. Then, according to U1, U2, and the resistance value of the reference resistor R1, the resistance value of the heating element R2 in this case may be calculated by using the following formula:

$${R}_{2} = {U}_{2} * {R}_{1} / ( {U}_{1} - {U}_{2} )$$

R₂ is the resistance value of the heating element R2, and R₁ is the resistance value of the reference resistor R1.

Finally, it should be noted that, in a time window, other than a final time segment (energy compensation time segment), for each other time segment, the resistance value of the heating element R2 in the corresponding time segment can be calculated through the foregoing method. In other words, the voltage of the heating element R2 needs to be sampled twice in each time segment and analog-to-digital conversion needs to be performed twice, as shown in FIG. 3 and FIG. 4.

Certainly, the resistance value of the heating element R2 may be calculated only in a first time segment of a time window through the foregoing method, as shown in FIG. 5. In addition, consumed energy of subsequent time segments each is calculated according to the resistance value.

A process of calculating actual power of the heating element R2 in a time segment is described below with reference to FIG. 3 (or FIG. 4).

First, in n time segments of a time window:
U₁ₜ₁ is a voltage U₁ detected by the voltage sampling module 14 in a heating period of a first time segment;
U₂ₜ₁ is a voltage U₂ detected by the voltage sampling module 14 in a non-heating period of the first time segment;
U₁ₜ₍ₙ₋₁₎ is the voltage U₁ detected by the voltage sampling module 14 in a heating period of an (n−1)^{th} time segment;
U₂ₜ₍ₙ₋₁₎ is the voltage U₂ detected by the voltage sampling module 14 in a non-heating period of the (n−1)^{th} time segment;
U₁ₜₙ is the voltage Un detected by the voltage sampling module 14 in a heating period of an n^{th} time segment;
t_{1A} is the heating period (duration for which the first switch circuit 12 is turned on and the second switch circuit 13 is turned off) of the first time segment;
t_{1B} is the non-heating period (duration for which the first switch circuit 12 is turned off and the second switch circuit 13 is turned on) of the first time segment;
t₁ is segment duration of the first time segment, in other words, t₁=t_{1A}+t_{1B};
t_{(n-1)A} is the heating period (duration for which the first switch circuit 12 is turned on and the second switch circuit 13 is turned off) of the (n−1)^{th} time segment;
t_{(n-1)B} is the non-heating period (duration for which the first switch circuit 12 is turned off and the second switch circuit 13 is turned on) of the (n−1)^{th} time segment;
tₙ₋₁ is segment duration of the (n−1)^{th} time segment, in other words, tₙ₋₁=t_{(n-1)A}+t_{(n-1)B};
t_{nA} is the heating period (duration for which the first switch circuit 12 is turned on and the second switch circuit 13 is turned off) of the n^{th} time segment (an energy compensation time segment);
t_{nB} is the non-heating period (duration for which the first switch circuit 12 and the second switch circuit 13 are simultaneously turned off) of the n^{th} time segment; and
tₙ is segment duration of the n^{th} time segment, in other words, tₙ=t_{nA}+t_{nB}.

By using the first time segment as an example, energy consumed by the heating element in the time segment is:

$${P}_{t 1 A} = {U}_{1 t 1} * {U}_{1 t 1} / {R}_{2} ; \\ {P}_{t 1 B} = {U}_{2 t 1} * {U}_{2 t 1} / {R}_{2} ; and \\ {E}_{t 1} = {P}_{t 1 A} * {t}_{1 A} + {P}_{t 1 B} * {t}_{1 B}$$

P_{t1A} is first actual power of the heating element in the heating period of the first time segment, P_{t2B} is second actual power of the heating element in the non-heating period of the first time segment, and Eₜ₁ is the energy consumed by the heating element in the first time segment.

It should be understood that, a method for calculating energy consumed by the heating element in another time segment is similar to the method. Details are not described herein. In addition, if the resistance value of the heating element is not detected in a non-heating period of a time segment, second actual power in the non-heating period is 0.

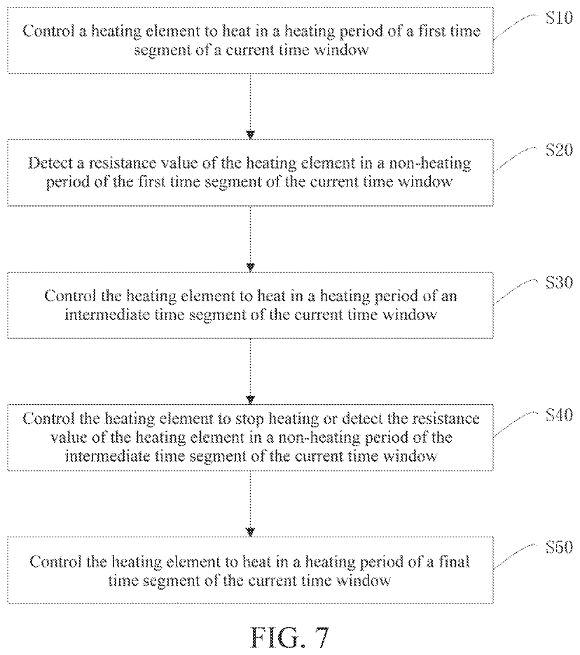

FIG. 7 is a flowchart of Embodiment 1 of a method for controlling an electronic atomization device according to the present invention. The method for controlling an electronic atomization device in this embodiment includes the following steps:
Step S10: Control a heating element to heat in a heating period of a first time segment of a current time window.
Step S20: Detect a resistance value of the heating element in a non-heating period of the first time segment of the current time window.
Step S30: Control the heating element to heat in a heating period of an intermediate time segment of the current time window, where the intermediate time segment is another time segment than the first time segment and a final time segment in the current time window, and the heating period of the intermediate time segment is related to consumed energy and consumed time of a time segment that has been run.
Step S40: Control the heating element to stop heating or detect the resistance value of the heating element in a non-heating period of the intermediate time segment of the current time window.
Step S50: Control the heating element to heat in a heating period of the final time segment of the current time window, where the heating period of the final time segment is related to consumed energy and consumed time of a time segment that has been run.

Further, in an optional embodiment, segment duration of time segments of the current time window is equal. In another optional embodiment, the segment duration of the time segments of the current time window is not exactly equal.

Further, in an optional embodiment, heating periods of time segments of the current time window are equal. In another optional embodiment, the heating periods of the time segments of the current time window are not exactly equal.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An electronic atomization device, comprising:
a heating element; and
a control module configured to:
control the heating element to heat in a heating period of a first time segment of a current time window, and detect a resistance value of the heating element in a non-heating period of the first time segment of the current time window;
control the heating element to heat in a heating period of an intermediate time segment of the current time window, and control the heating element to stop heating or detect the resistance value of the heating element in a non-heating period of the intermediate time segment of the current time window; and
control the heating element to heat in a heating period of a final time segment of the current time window,
wherein the intermediate time segment is a different time segment than the first time segment and the final time segment in the current time window, and
wherein the heating period of the intermediate time segment and the heating period of the final time segment are respectively related to consumed energy and consumed time of a time segment that has been run.

2. The electronic atomization device of claim 1, wherein the heating period and the non-heating period of the first time segment of the current time window are initial set values, or
wherein the heating period and the non-heating period of the first time segment of the current time window are related to running of a plurality of time segments in a previous time window.

3. The electronic atomization device of claim 1, wherein segment duration of time segments of the current time window is equal, or
wherein segment duration of the time segments of the current time window is not exactly equal.

4. The electronic atomization device of claim 3, wherein segment duration of the intermediate time segment is determined by using Formula 1:
tₓ=t_{left(x-1)}/gₓ (Formula 1),
wherein tₓ is segment duration of an x^{th} time segment, x=2, 3, . . . , or n−1, n is a total quantity of time segments of the current time window, gₓ is a set value corresponding to the x^{th} time segment, and gₓ is an integer greater than 1.

5. The electronic atomization device of claim 1, wherein heating periods of time segments of the current time window are equal, or
wherein heating periods of the time segments of the current time window are not exactly equal.

6. The electronic atomization device of claim 1, wherein the heating period of the intermediate time segment and the heating period of the final time segment are respectively related to actual power of a previous time segment, remaining duration of the current time window, and remaining energy of the current time window.

7. The electronic atomization device of claim 6, wherein, if the heating element is controlled to stop heating in the non-heating period of the intermediate time segment of the current time window, the heating period of the intermediate time segment is determined by using Formula 2:
t_{left(x-1)}*P_{t(x-1)A}*t_{xA}/tₓ=E_{left(x-1)} (Formula 2),
wherein, if the resistance value of the heating element is detected in the non-heating period of the intermediate time segment of the current time window, the heating period of the intermediate time segment is determined by using Formula 3:
t_{left(x-1)}*(P_{t(x-1)A}*t_{xA}+P_{t(x-1)B}*(tₓ−t_{xA}))/tₓ=E_{left(x-1)} (Formula 3), and
wherein tₓ is segment duration of an x^{th} time segment, x=2, 3, . . . , or n−1, n is a total quantity of time segments of the current time window, t_{xA} is a heating period of the x^{th} time segment, t_{left(x-1)} is a remaining duration of the current time window, P_{t(x-1)A} is first actual power of the heating element in a heating period of an (x−1)^{th} time segment, P_{t(x-1)B} is second actual power of the heating element in a non-heating period of the (x−1)^{th} time segment, and E_{left(x-1)} is a remaining energy of the current time window.

8. The electronic atomization device of claim 6, wherein the heating period of the final time segment is determined as follows:
if first actual power of the heating element in a heating period of a penultimate time segment is greater than or equal to a ratio of the remaining energy to the remaining duration of the current time window, the ratio is used as the heating period of the final time segment; and
if the first actual power of the heating element in the heating period of the penultimate time segment is less than the ratio of the remaining energy to the remaining duration of the current time window, the remaining duration is used as the heating period of the final time segment.

9. The electronic atomization device of claim 1, further comprising:
a first switch circuit;
a second switch circuit;
a reference resistor; and
a voltage sampling module,
wherein a first end of the second switch circuit and a first end of the first switch circuit are respectively connected to a positive end of a power supply,
wherein a second end of the second switch circuit is connected to a first end of the reference resistor,
wherein a second end of the reference resistor and a second end of the first switch circuit are respectively connected to a first end of the heating element,
wherein a second end of the heating element is grounded,
wherein an input end of the voltage sampling module is connected to the first end of the heating element, and
wherein an output end of the voltage sampling module is connected to a voltage detection end of the control module.

10. A method for controlling an electronic atomization device, comprising:
controlling a heating element to heat in a heating period of a first time segment of a current time window;
detecting a resistance value of the heating element in a non-heating period of the first time segment of the current time window;
controlling the heating element to heat in a heating period of an intermediate time segment of the current time window, the intermediate time segment being a different time segment than the first time segment and a final time segment in the current time window, the heating period of the intermediate time segment being related to consumed energy and consumed time of a time segment that has been run;
controlling the heating element to stop heating or detecting a resistance value of the heating element in a non-heating period of the intermediate time segment of the current time window; and
controlling the heating element to heat in a heating period of the final time segment of the current time window, the heating period of the final time segment being related to consumed energy and consumed time of a time segment that has been run.

11. The method of claim 10, wherein segment duration of time segments of the current time window is equal, or
wherein segment duration of the time segments of the current time window is not exactly equal.

12. The method of claim 10, wherein heating periods of time segments of the current time window are equal, or
wherein heating periods of the time segments of the current time window are not exactly equal.
